(19) United States
(12) Patent Application Publication
(10) Pub. No.: US 2006/0020682 A1
(43) Pub. Date: Jan. 26, 2006

(54) System and method for connecting unix utilities to the internet

(75) Inventor: Jonnala Uday Kiran, Bangalore (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT CO., L.P.

(21) Appl. No.: 11/185,809

(22) Filed: Jul. 21, 2005

(30) Foreign Application Priority Data
Jul. 23, 2004 (GB) GB 0416482.8

(51) Int. Cl. G06F 15/16

(52) U.S. Cl. 709/217

(57) ABSTRACT

A technique to link a computer system using a Unix operating system with a remote computer via the Internet to access data residing on the remote computer and to manipulate the accessed data on the computer system. This is achieved by checking an argument in a received Unix command including the argument for an Internet URL. If the argument is found to be an Internet URL, then an Internet URL protocol library is searched for associated Internet URL. Communication between the computer system using the Unix operating system and the remote computer is then initiated via the Internet, if the associated Internet URL is found. Once the communication is established between the computer system and the remote computer via the Internet, desired data residing on the remote computer is accessed and manipulated on the computer system based on the intended function of the Unix command.

### TECHNICAL FIELD OF THE INVENTION

The present invention relates generally to communications between different domains, and more particularly relates to establishing communications between Unix domain and Internet.

### BACKGROUND OF THE INVENTION

Interoperability between different domains is important. For example, interoperability includes ability to establish communication between one domain and another domain to access and/or manipulate data residing in either of the domains. More particularly, certain operating systems have communication protocols that are difficult for other domains to accommodate when attempting to establish communications between the two systems. For example, Unix does not have interoperability between a computer system using the Unix operating system and the Internet. Currently, Unix utilities can only be used to access and/or manipulate data in a computer system where the Unix operating system is residing or data residing remotely in a host computer.

This problem becomes severe when accessing data residing over the Internet using the Unix operating system. Currently, the functionalities of the Unix utilities are restricted to local machine and they do not extend to the Internet. Therefore, to access and/or manipulate data residing over the Internet, when using a computer system using the Unix operating system, the data has to be downloaded from the Internet to the local machine and either stored in a local file or a remote file (i.e., the data has to be transferred from the Internet to the Unix domain and then the transferred data has to be uploaded into the Unix operating system to store either in the local file or the remote file). This generally requires several steps and can be burdensome and time consuming when operating in a Unix environment.

For example, in order to currently access and print files residing over the Internet, when using a computer system having a Unix operating system, one option available is to download the files from the Internet into either a local file or a remote file and then print the files using the Unix print utilities when the file is in the local directory of the Unix operating system. The other option available is to either open the Webpage while on the Internet using an Internet Browser and save the file into a local directory and print the files or manually go through each Webpage individually and print the files.

Similarly, to find and get the files residing on a specific ftp site using the traditional way one has to browse the specific Website using the ftp interface and list all the files. This can require several steps just to get a list of all the files. The following example illustrates the steps required to find and list the files residing on the ftp site.

$ ftp someremotesite.domine.com

| | |
|---|---|
| ftp> cd/pub/datafiles | // change the directory to the required directory |
| ftp>bin | // Set the option to get the files in binary mode |
| ftp>prompt | // Don't ask for confirmation |
| ftp>ls | // List the files |
| ftp>get open<filename> | // Get the file |
| ftp>quite | // Quit from ftp session |

It can be seen from the above example that using the current approach to find files residing in a Website and list them can require nearly 7 steps when accessing the files from a computer using the Unix operating system. This can be very time consuming and annoying. In addition, the size of certain files to be downloaded from the Internet to the local machine may be restricted by the amount of memory available in the local machine. Furthermore, a user can be constrained to browser availability as well when using Unix utilities to access and/or manipulate data residing over the Internet.

### SUMMARY OF THE INVENTION

According to a first aspect of the invention there is provided a method of initiating communication between a computer system using a Unix operating system and a remote computer via the Internet, the method comprising the steps of:
a) entering a Unix command along with an argument into a computer system using a Unix operating system;
b) initiating communication between the computer system using the Unix operating system and a remote computer over Internet as a function of the argument;
c) accessing data in a remote computer over the Internet based on the argument; and
d) performing intended function by the Unix command in the computer system on the accessed data.

Preferably, the entered argument is checked for an Internet URL. If the argument is an Internet URL, then the Unix command is invoked and searched for associated Internet URL protocol in an Internet URL protocol library based on the Internet URL by the invoked Unix command. Communication between the computer system and the remote computer is then initiated using the associated Internet URL protocol by the invoked Unix command.

According to a second aspect of the invention there is provided an article including a storage medium having instructions that, when executed by a computing platform, result in execution of a method comprising:
a) entering a Unix command along with an argument into a computer system using a Unix operating system;
b) initiating communication between the computer system using the Unix operating system and a remote computer over Internet as a function of the argument;
c) accessing data in a remote computer over the Internet based on the argument; and
d) performing intended function by the Unix command in the computer system on the accessed data.

According to a third aspect of the invention there is provided a computer system for initiating communication between a computer system using a Unix operating system and a remote computer over the Internet to access data on the remote computer and perform the intended function on the computer system, the system comprising:
a) a user input device to enter a Unix command along with an argument;
b) a Unix shell of a computer system using a Unix operating system coupled to the user input device that receives the entered Unix command along with the argument from the user input device, wherein the Unix shell determines if the received argument is an URL; and
c) an Internet URL protocol library coupled to the Unix shell that comprises URL protocols necessary to establish communication between Internet and the computer system, wherein the Unix shell invokes the Unix command, and wherein the invoked Unix command searches the Internet URL protocol library for associated URL protocol and initiates communication between the computer system and the Internet using the associated URL protocol, wherein the Unix shell to access a file on the Internet using the associated URL protocol, and wherein the Unix shell performs the Unix command function on the accessed file.

### BRIEF DESCRIPTION OF THE DRAWINGS

FIG. 1 is a flowchart illustrating an example method of connecting Unix domain with Internet according to an embodiment of the present invention.

FIG. 2 is a block diagram of a typical computer system for connecting the Unix domain with Internet according to various embodiments of the present invention, such as the one shown in FIG. 1.

### DETAILED DESCRIPTION OF THE INVENTION

In the following detailed description of the various embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments may be utilized and that changes may be made without departing from the scope of the present invention. The following detailed description is, therefore, not to be taken in a limiting sense, and the scope of the present invention is defined only by the appended claims.

The terms “computer” and “computer system” are used interchangeably throughout the document. Also, the terms “bridge tool set” and “Internet URL protocol library” are used interchangeably throughout the document.

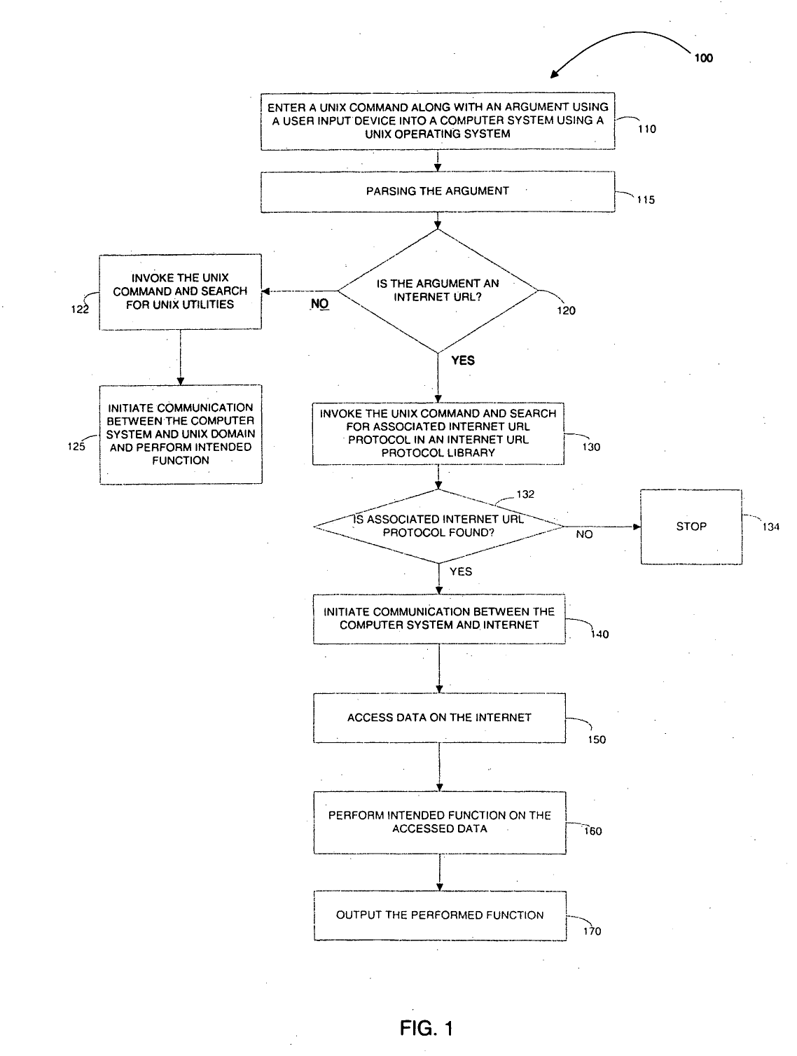

FIG. 1 illustrates an example method 100 of linking a computer using a Unix operating system with Internet to extend the functionalities of the Unix utilities to Internet. At 110, in this example method 100 a Unix command along with an argument is entered into a computer system using a Unix operating system. The Unix command can be a Unix utility. Unix utility can include one or more commands, such as lp,find, grep, cat, wc,file, tar, spell, more, diff, dmp, and the like. At 115, the entered Unix command along with the argument is received and the argument is parsed from the entered Unix command including the argument.

At 120, the parsed argument is checked to see whether it is an Internet URL (Uniform Resource Locator). The Internet URL can be a web address, such as a website address or FTP (File Transfer Protocol) site address. If the received argument is an Internet URL, the method 100 goes to step 130, otherwise the method goes to step 122 and invokes the Unix command and searches for Unix utilities and executes the associated Unix utility, if found. At step 124, communication between the computer system and the Unix domain is initiated by executing the associated Unix utility, if found and performs the intended function by the Unix command.

At 130, the received Unix command is invoked. The invoked Unix command searches for associated Internet URL protocol in an Internet URL protocol library residing in the computer system. The Internet URL protocol library can include protocols, such as HTTP (Hyper Text Transfer Protocol), FTP, HTTPS (Hyper Text Transfer Protocol Secure), Gopher and other such Internet protocols that facilitate in accessing data residing over the Internet. These Internet URL protocols stored in the Internet URL protocol library can read HTML contents residing on the remote computers and return the data back to the computer system operating in the Unix domain in a text format, so that the Unix utilities can process the information in the text format. The Internet URL protocol library can use the existing Unix system without requiring any modifications to read the web contents using Java URL and URL connection classes by invoking the Java methods using program languages, such as C, since most of the current Unix utilities are written in C programming language. The internet URL protocol library can be developed to link with Unix utilities to extend the capabilities to Internet. Java is an object-oriented language similar to programming language C++.

At 132, the method 100 checks to see whether an associated Internet URL protocol is found. If not, the method 100 goes to Act 134 and stops. If so, the method 100 goes to Act 140.

At 140, the associated Internet URL protocol is executed to initiate communication between the computer system and the remote computer via the Internet, if the associated Internet URL protocol is found by the invoked Unix command. In some embodiments, communication between the computer system and the remote computer via the Internet is established using the associated Internet URL protocol by the invoked Unix utility.

At 150, data residing in the remote computer is accessed via the initiated communication between the computer system and the remote computer via the Internet based on the argument. In some embodiments, a file stored in the remote computer is accessed via the Internet after establishing a communication between the computer system and the remote computer based on the web address. In other embodiments, HTML contents stored in a remote computer system is read using the associated Internet URL protocol and the read HTML contents are returned to the Unix utility in the Unix domain. The accessed data can be a file, Webpage, and/or text data.

At 160, intended function by the Unix command is performed on the accessed data in the computer system using the Unix operating system. In some embodiments, the intended Unix utility function is performed on the accessed file or Webpage using the Unix domain. At 170, after performing the Unix utility function, the manipulated data is outputted onto a display device, such as a computer display device.

Following are some examples that illustrate how the above-described technique extends the capabilities of the Unix utilities to access and/or manipulate files residing over the Internet according to various embodiments of the present invention.
1. The following is an example of a Unix command including the “Unix wild card” mechanism along with the associated Internet URL that illustrates how it can be used to print a complete set of files residing over the Internet without having to download the files to the local machine or to having to go through each file using the browser:
   $lp http://www.someebooks.com/book2001/*
2. The following is another example of a Unix command along with the associated Internet URL that illustrate how it can be used to find files in an anonymous ftp site:
   $find. -name ‘foo.html’ftp://someremotesite.domaine.com/pub/datafiles
3. The following is another example of a Unix command along with the associated Internet URL that illustrate how it can be used to extract files residing in a remote computer based on pattern matching:
   $grep “Multi Threading Explained” http://www.weekly_technical_topics.html
4. The following is another example of a Unix command along with the associated Internet URL that illustrate how it can be used to obtain text data from a Webpage without having to log on to the browser:
   $cat www.somenews.com // Displays the contents of the Webpage in text format.

It can be seen from the above examples that the framework by using the Unix utilities along with the Internet URL can accomplish the accessing and/or manipulating data residing over the Internet in a single step as opposed to requiring several steps in the traditional way.

Although the flowchart 100 includes steps 110-170 that are arranged serially in the exemplary embodiments, other embodiments of the subject matter may execute two or more steps in parallel, using multiple processors or a single processor organized as two or more virtual machines or sub-processors. Moreover, still other embodiments may implement the steps as two or more specific interconnected hardware modules with related control and data signals communicated between and through the modules, or as portions of an application-specific integrated circuit. Thus, the exemplary process flow diagrams are applicable to software, firmware, and/or hardware implementations.

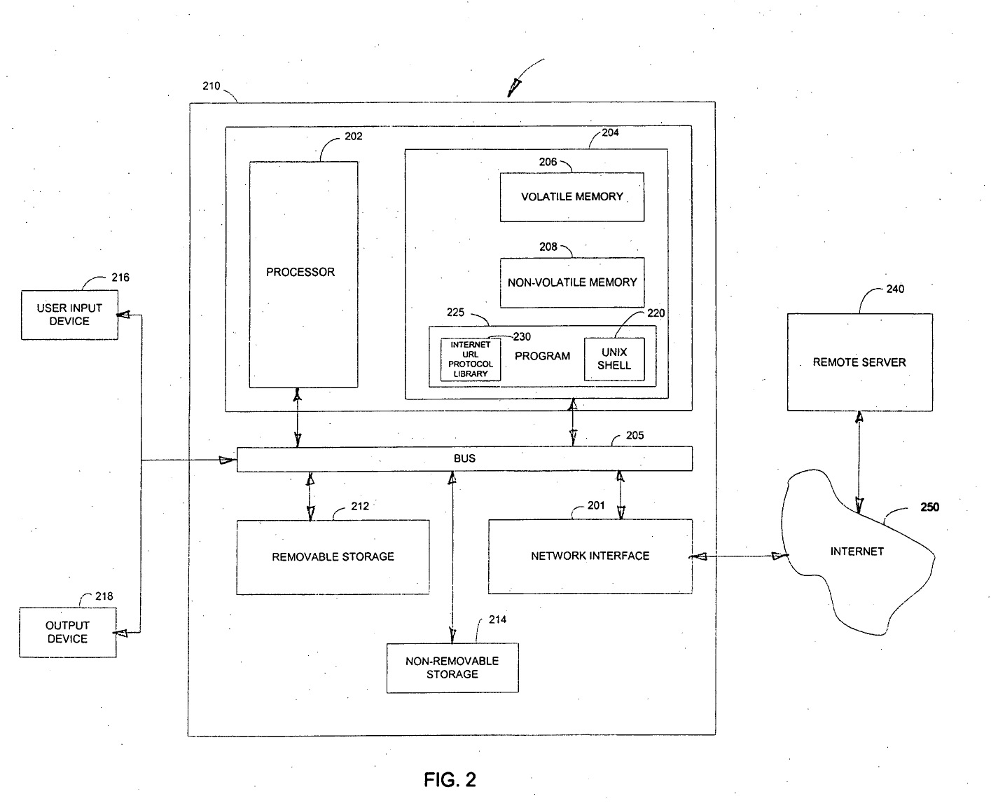

Various embodiments of the present invention can be implemented in software, which may be run in the environment shown in FIG. 2 (to be described below) or in any other suitable computing environment. The embodiments of the present invention are operable in a number of general-purpose or special-purpose computing environments. Some computing environments include personal computers, general-purpose computers, server computers, hand-held devices (including, but not limited to, telephones and personal digital assistants (PDAs) of all types), laptop devices, multi-processors, microprocessors, set-top boxes, programmable consumer electronics, network computers, minicomputers, mainframe computers, distributed computing environments and the like to execute code stored on a computer-readable medium. The embodiments of the present invention may be implemented in part or in whole as machine-executable instructions, such as program modules that are executed by a computer. Generally, program modules include routines, programs, objects, components, data structures, and the like to perform particular tasks or to implement particular abstract data types. In a distributed computing environment, program modules may be located in local or remote storage devices.

FIG. 2 shows an example of a suitable computing system environment for implementing embodiments of the present invention. FIG. 2 and the following discussion are intended to provide a brief, general description of a suitable computing environment in which certain embodiments of the inventive concepts contained herein may be implemented.

A general computing device, in the form of a computer 210, may include a processor 202, memory 204, removable storage 212, and non-removable storage 214. Computer 210 additionally includes a bus 205 and a network interface (NI) 201.

The computer 210 may include or have access to a computing environment that includes one or more user input devices 216 and one or more output devices 218. The user input device 216 can include a keyboard, a mouse, a trackball, a cursor detection keys, and/or the like. The output device 218 can include a computer display device and the like. The network interface 201 can be a USB connection. The computer 210 may operate in a networked environment using the network interface 201 to connect to one or more remote computers 240 via Internet 250. The remote computer 240 may include a personal computer, server, router, network PC, a peer device or other network node, and/or the like. The network interface 201 can also include a Local Area Network (LAN), a Wide Area Network (WAN), and/or other networks.

The memory 204 may include volatile memory 206 and non-volatile memory 208. A variety of computer-readable media may be stored in and accessed from the memory elements of computer 210, such as volatile memory 206 and non-volatile memory 208, removable storage 212 and non-removable storage 214. Computer memory elements can include any suitable memory device(s) for storing data and machine-readable instructions, such as read only memory (ROM), random access memory (RAM), erasable programmable read only memory (EPROM), electrically erasable programmable read only memory (EEPROM), hard drive, removable media drive for handling compact disks (CDs), digital video disks (DVDs), diskettes, magnetic tape cartridges, memory cards, Memory Sticks™, and the like; chemical storage; biological storage; and other types of data storage.

“Processor” or “processing unit,” as used herein, means any type of computational circuit, such as, but not limited to, a microprocessor, a microcontroller, a complex instruction set computing (CISC) microprocessor, a reduced instruction set computing (RISC) microprocessor, a very long instruction word (VLIW) microprocessor, explicitly parallel instruction computing (EPIC) microprocessor, a graphics processor, a digital signal processor, or any other type of processor or processing circuit. The term also includes embedded controllers, such as generic or programmable logic devices or arrays, application specific integrated circuits, single-chip computers, smart cards, and the like. The “computer” 210 as user herein, means a computer system using a Unix operating system.

Embodiments of the present invention may be implemented in conjunction with program modules, including functions, procedures, data structures, application programs, etc., for performing tasks, or defining abstract data types or low-level hardware contexts.

Machine-readable instructions stored on any of the above-mentioned storage media are executable by the processor 202 of the computer 210. For example, a computer program 225 may comprise machine-readable instructions capable of extending functionalities of Unix utilities to the Internet 250 according to the teachings and herein described embodiments of the present invention. As shown in FIG. 2, the computer program 225 includes a Unix shell 220 and an Internet URL protocol library 230. The Internet protocol library 230 includes Internet protocols necessary to establish communications between the computer system 210 and the remote computer 240. In one embodiment, the computer program 225 may be included on a CD-ROM and loaded from the CD-ROM to a hard drive in non-volatile memory 208. The machine-readable instructions cause the computer 210 to link a computer system using the Unix operating system 210 with a remote computer 240 via the Internet 230 to extend functionalities of the Unix utilities to the Internet according to the embodiments of the present invention.

In operation, a Unix command along with an argument entered using the user input device 216 is received by operable Unix shell 220 residing in the processor 202. The Unix shell 220 is a special program used as an interface between the user and the heart of the Unix operating system, a program called the kernel. The kernel is loaded into the memory 204 at boot-up time and manages the computer system 210 until shutdown. The kernel creates and controls processes, and manages memory 206 and 208, file systems, communications, and so forth. All other programs, including shell programs, reside in the memory 204. The kernel loads those programs into memory 204 and executes these programs. The Unix shell 220 is a utility program that starts up when the user logs on. The Unix shell 220 allows users to interact with the kernel by interpreting commands that are typed either at a command line or in a script file.

The Unix shell 220 checks whether or not the received argument is an Internet URL. If the received argument is an Internet URL, then the Unix shell 220 invokes the received Unix command. The Unix command searches the Internet URL protocol library for associated Internet URL protocol upon invoking the Unix command. The Unix shell 220 then executes the associated Internet URL to initiate communication between the computer system 210 and the remote computer 240 via the Internet 250 upon finding the associated Internet URL protocol. The Unix shell 220 then accesses an intended file on the remote computer 240 via the Internet 250 using the associated Internet URL protocol. The Unix shell 220 then performs the intended Unix command function on the accessed file. The above-described technique of establishing such communication connection between the computer system 210 operating in a Unix domain and the remote computer 240 via the Internet 250 is explained in more detail with reference to FIG. 1.

The communication technique of the present invention is modular and flexible in terms of usage in the form of a “Distributed Configurable Architecture”. As a result, parts of the Unix framework may be placed at different points of a network, depending on the model chosen. For example, the technique can be deployed in a server and the input and output modules streamed over from a client to the server and back, respectively.

Advantageously, the Unix system does not have to be reconfigured in any way nor or any special Unix scripts required to provide interoperability between Unix domain and Internet 250 according to the present invention. The technique links the Unix utilities to the Internet 250 using the aid of an Internet URL protocol library residing in the computer system 210 operating in the Unix domain. Basically, the technique extends the functionalities of the Unix utilities to the Internet 250. Furthermore, the technique provides interoperability between Unix domain (i.e., a computer system operating on a Unix platform) and Internet domain.

The above description is intended to be illustrative, and not restrictive. Many other embodiments will be apparent to those skilled in the art. The scope of the invention should therefore be determined by the appended claims, along with the full scope of equivalents to which such claims are entitled.

The above-described methods and systems provide various embodiments for connecting Unix domain to Internet domain to access files or WebPages on the Internet. It is to be understood that the above-description is intended to be illustrative, and not restrictive. Many other embodiments will be apparent to those of skill in the art upon reviewing the above-description. The scope of the subject matter should, therefore, be determined with reference to the following claims, along with the full scope of equivalents to which such claims are entitled.

As shown herein, the present invention can be implemented in a number of different embodiments, including various methods, a circuit, an I/O device, a system, and an article comprising a machine-accessible medium having associated instructions.

Other embodiments will be readily apparent to those of ordinary skill in the art. The elements, algorithms, and sequence of operations can all be varied to suit particular requirements. The operations described-above with respect to the method illustrated in FIG. 2 can be performed in a different order from those shown and described herein.

FIGS. 1 and 2 are merely representational and are not drawn to scale. Certain portions thereof may be exaggerated, while others may be minimized. FIGS. 1-2 illustrate various embodiments of the invention that can be understood and appropriately carried out by those of ordinary skill in the art.

It is emphasized that the Abstract is provided to comply with 37 C.F.R. § 1.72(b) requiring an Abstract that will allow the reader to quickly ascertain the nature and gist of the technical disclosure. It is submitted with the understanding that it will not be used to interpret or limit the scope or meaning of the claims.

In the foregoing detailed description of the embodiments of the invention, various features are grouped together in a single embodiment for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims are hereby incorporated into the detailed description of the embodiments of the invention, with each claim standing on its own as a separate preferred embodiment.

1. A method comprising:
entering a Unix command along with an argument into a computer system using a Unix operating system;
initiating communication between the computer system using the Unix operating system and a remote computer over Internet as a function of the argument;
accessing data in a remote computer over the Internet based on the argument; and
performing intended function by the Unix command in the computer system on the accessed data.

2. The method of claim 1, wherein initiating the communication between the computer system using the Unix operating system and the Internet as a function of the argument comprises:
receiving the entered Unix command along with the argument;
parsing the argument from the received Unix command along with the argument;
determining if the argument is an Internet URL;
if so, invoking the Unix command and searching for associated Internet URL protocol in an Internet URL protocol library based on the Internet URL by the invoked Unix command; and
executing the associated Internet URL protocol to initiate the communication between the computer system and the remote computer over the Internet, if the associated Internet URL protocol is found.

3. The method of claim 2, further comprising:
if not, invoking the Unix command, wherein the invoked command triggers shell to search for Unix utilities in accessible directories to find an associated Unix utility; and
executing the Unix command with the argument using the associated Unix utility to initiate communication between the computer system and the Unix domain.

4. A method of connecting a computer system using a Unix domain to a remote computer via Internet comprising:
entering a Unix utility along with an argument;
determining if the argument is a web address;
if so, invoking the Unix utility and searching for associated Internet URL protocol in an Internet URL protocol library based on the web address by the invoked Unix utility;
establishing communication between the computer system and the remote computer via the Internet using the associated Internet URL protocol by the invoked Unix utility;
accessing a file stored in the remote computer via the Internet based on the web address; and
performing the Unix utility function on the accessed file in the computer system using the Unix domain.

5. The method of claim 4, wherein the Internet URL protocol comprises a transfer protocol selected from the group consisting of HTTP, FTP, HTTPS, and Gopher.

6. The method of claim 4, wherein the Unix utility comprises one or more commands selected from the group consisting of lp, find, grep, cat, wc, file, tar, spell, more, diff, and cmp.

7. The method of claim 4, wherein accessing the file on the remote computer via the Internet based on the web address comprises:
using the associated Internet URL protocol to read HTML contents on a remote computer system and returning the read HTML contents to the Unix utility in the Unix domain.

8. The method of claim 7, wherein the contents comprise text elements.

9. An article comprising:
a storage medium having instructions that, when executed by a computing platform, result in execution of a method comprising:
entering a Unix command along with an argument into a computer system using a Unix operating system;
initiating communication between the computer system using the Unix operating system and a remote computer over Internet as a function of the argument;
accessing data in a remote computer over the Internet based on the argument; and
performing intended function by the Unix command in the computer system on the accessed data.

10. The article of claim 9, wherein initiating the communication between the computer system using the Unix operating system and the Internet as a function of the argument comprises:
receiving the entered Unix command along with the argument;
parsing the argument from the received Unix command along with the argument;
determining if the argument is an Internet URL;
if so, invoking the Unix command and searching for associated Internet URL protocol in an Internet URL protocol library based on the Internet URL by the invoked Unix command; and
executing the associated Internet URL protocol to initiate the communication between the computer system and the remote computer over the Internet, if the associated Internet URL protocol is found.

11. The article of claim 10, further comprising:
if not, invoking the Unix command, wherein the invoked command triggers shell to search for Unix utilities in accessible directories to find an associated Unix utility; and
executing the Unix command with the argument using the associated Unix utility to initiate communication between the computer system and the Unix domain.

12. A computer system comprising:
a user input device to enter a Unix command along with an argument;
a Unix shell of a computer system using a Unix operating system coupled to the user input device that receives the entered Unix command along with the argument from the user input device, wherein the Unix shell determines if the received argument is an URL; and
an Internet URL protocol library coupled to the Unix shell that comprises URL protocols necessary to establish communication between Internet and the computer system, wherein the Unix shell invokes the Unix command, and wherein the invoked Unix command searches the Internet URL protocol library for associated URL protocol and initiates communication between the computer system and the Internet using the associated URL protocol, wherein the Unix shell to access a file on the Internet using the associated URL protocol, and wherein the Unix shell performs the Unix command function on the accessed file.

13. The system of claim 12, further comprising:
an output device coupled to the computer system that outputs the performed Unix command function on the accessed file.

14. The system of claim 12, wherein the user input device comprises a device selected from the group consisting of a keyboard, a mouse, a trackball, and a cursor detection keys.

15. The system of claim 12, wherein the output device comprises a computer display device.

16. A communication system comprising:
a processor;
a memory coupled to the processor;
a remote computer;
Internet;
a network interface, wherein the processor and the remote computer are operatively connectible via the network interface and the Internet;
a user input device coupled to the processor to enter a Unix command along with an argument;
operable Unix shell on the processor that receives the entered Unix command along with the argument from the user input device, wherein the Unix shell determines if the received argument is an Internet URL; and
an Internet URL protocol library stored in the processor, wherein the Internet URL protocol library comprises Internet URL protocols necessary to establish communication between the remote computer and the computer system via the Internet, wherein the Unix shell invokes the Unix command, and wherein the invoked Unix command searches the bridge tool set for associated Internet URL protocol and initiates communication between the computer system and the remote computer via the Internet using the associated Internet URL protocol, wherein the Unix shell to access a file on the remote computer via the Internet using the associated Internet URL protocol, and wherein the Unix shell performs the Unix command function on the accessed file.

17. The system of claim 16, further comprising:
an output device coupled to the processor that outputs the performed Unix command function on the accessed file.

18. The system of claim 17, wherein the accessed file comprises a file selected from the group consisting of a Webpage and a text file.
